(19) United States
(12) Patent Application Publication
(10) Pub. No.: US 2005/0213576 A1
(43) Pub. Date: Sep. 29, 2005

(54) Multicasting in wireless networks

(76) Inventor: Adrian P. Stephens, Cambridge (GB)

Correspondence Address: Stuart A. Whittington;Intel Corporation, 2200 Mission College Blvd., Santa Clara, CA, 95052, US

(21) Appl. No.: 10/812,660

(22) Filed: Mar. 29, 2004

(51) Int. Cl. H04L 12/56

(52) U.S. Cl. 370/390; 370/432; 370/338

(57) ABSTRACT

According to various aspects, methods for multicasting in wireless networks may include one or more client devices sending requests for delivery of application data packets to a network access station. The requests may include a multicast address and QoS attributes. The network access station may create a multicast schedule which coordinates the multicast deliver with power saving protocols of the client device so that the client devices will be awake when the multicast occurs. The client devices may also instigate removal of a multicast schedule when the application data packets are received or no longer needed by sending schedule deletion requests to the access station. When a deletion requests is received from the last client device associate with a multicast schedule, the schedule may be removed. Additional embodiments and implementations are also disclosed.

### BACKGROUND OF THE INVENTION

It is becoming more attractive to distribute information, such as voice and/or video data streams, to multiple client devices using a broadcast or multicast address. Multicast delivery may be used to avoid duplication of transmitted data used by multiple client devices running similar applications.

Unique problems exist in some wireless networks, such as a wireless local area network (WLAN), which can make delivery of multicast information difficult. One such problem is that battery powered wireless devices often implement power saving protocols in which, during some periods, the devices may use a low-power mode or sleep mode in order to reduce power consumption. In this mode, broadcast frames or packets to be delivered to a wireless device are often buffered by a network access station, for example an access point (AP) or base station, and delivered according to a power-saving protocol. The power-saving protocol may coordinate a delivery of the frames or packets to occur during the periods that the wireless device is awake (e.g., not in sleep mode).

Therefore, there may often be a compromise between the delay for delivering data and the power-saving performance of a battery-powered device. This compromise may often be made by the network access point (AP) without any knowledge of the applications, for example programs residing on wireless devices, needing the broadcast information. For multicasting, coordination of power-saving techniques for multiple battery-powered wireless devices may be needed so that individual devices may receive a multicast.

### BRIEF DESCRIPTION OF THE DRAWING

Aspects, features and advantages of the present invention will become apparent from the following description of the invention in reference to the appended drawing in which like numerals denote like elements and in which:

FIG. 1 is block diagram of a wireless network according to one embodiment of the present invention;

FIG. 2 is a flow chart detailing a method for delivering and receiving information in a wireless network according to various embodiments of the present invention;

FIG. 3 is a block diagram of an example embodiment for a wireless device adapted to perform one or more of the methods of present invention; and

FIG. 4 is a block diagram of an example embodiment for a network access station adapted to perform one or more of the methods of the present invention.

### DETAILED DESCRIPTION OF THE INVENTION

While the following detailed description may describe example embodiments of the present invention in relation to wireless networks utilizing Orthogonal Frequency Division Multiplexing (OFDM) modulation, the embodiments of present invention are not limited thereto and, for example, can be implemented using other modulation and/or coding schemes where suitably applicable. Further, while example embodiments are described herein in relation to wireless local area networks (WLANs), the invention is not limited thereto and can be applied to other wireless networks where multicast delivery may presents similar challenges. Such networks specifically include, but are not limited to, wireless metropolitan area networks (WMANs), wireless personal area networks (WPANs) and wireless wide area networks (WWANs).

The following inventive embodiments may be used in a variety of applications including transmitters and receivers of a radio system, although the present invention is not limited in this respect. Radio systems specifically included within the scope of the present invention include, but are not limited to, wireless devices including network devices such as network interface cards (NICs), network adaptors, base stations, access points (APs), gateways, bridges, hubs and cellular radiotelephones. Further, the radio systems within the scope of the invention may include cellular radiotelephone systems, satellite systems, personal communication systems (PCS), two-way radio systems, one-way pagers, two-way pagers, personal computers (PCs), personal digital assistants (PDAs), personal computing accessories (PCAs) and all future arising systems which may be related in nature and to which the principles of the inventive embodiments could be suitably applied.

As used herein, a multicast address designates a device(s) from which multiple user stations could substantially simultaneously obtain information even though the device(s) corresponding to the address may not ultimately be the originating source device as explained further below. Further, a multicast schedule means a schedule for delivery of information from the device(s) corresponding to the multicast address. Accordingly, there is no requirement in the inventive embodiments that more than one station solicit (e.g., via a request), or is selected to receive, transmitted information. In other words, a multicast address and/or multicast schedule could be used for delivery of information to a single device if desired.

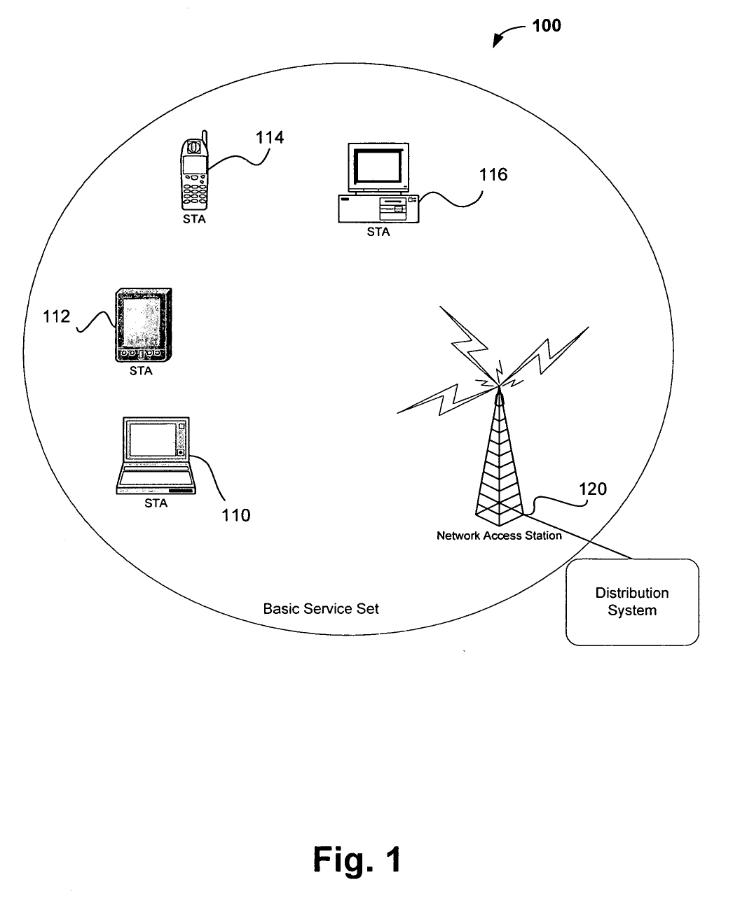

Turning to FIG. 1, a wireless communication system 100 according to one embodiment of the invention may include one or more user stations 110, 112, 114, 116 and one or more network access stations 120. System 100 may be any type of wireless network such as a wireless local area network (WLAN), wireless wide area network (WWAN) or cellular network where user stations 110-116 (also referred to as “clients”) communicate with network access station 120 via an air interface.

Depending on the desired implementation, system 100 may further include one or more other wired or wireless network devices as desired, for example additional basic service set (BSS), distribution system (DS) and/or ad-hoc network components. In certain embodiments system 100 may be an adaptive OFDM wireless local area network although the embodiments of the invention are not limited in this respect. OFDM is the modulation currently used in many wireless applications including the Institute of Electrical and Electronic Engineers (IEEE) 802.11(a) and (g) standards for WLANs.

As previously discussed, battery powered wireless devices such as clients 110, 112 and 114 may utilize power saving protocols where during certain periods, clients 110-114 operate in a low power mode coordinated with network access station 120. In certain WLAN embodiments, one or more of user stations (STAs) (e.g. clients 110-114) and/or network access points (APs) (e.g., 120) may be adapted to provide various quality of service (QoS) levels, although the inventive embodiments are not limited in this respect. QoS stations (QSTAs) and QoS access points (QAPs) may be implemented in network 100 to facilitate the exchange of information using various user priorities (UPs) in order to support applications with QoS requirements.

In one example implementation eight UPs may be identified for each media access control (MAC) service data unit (MSDU) to denote a traffic category (TC) reflecting a QoS level. QoS levels may be negotiated in this example implementation by exchanging QoS characteristics of a data flow to and from non-AP QSTAs. In one embodiment, these QoS characteristics are negotiated as part of a traffic specification (TSPEC) however; the embodiments of the invention are in no way limited to this example. A TSPEC describes the traffic characteristics and QoS requirements of a traffic stream (TS). The main purpose of a TSPEC is to reserve resources within an AP (sometimes referred to a hybrid coordinator (HC)) and modify its scheduling behavior. While TSPEC requests and responses are used in certain example implementations of the inventive embodiments as described below, the present invention is not limited to any specific protocols or message formats for communications and scheduling between various user stations and network access stations.

Although detailed QoS configurations are not relevant to the scope of this disclosure, the general capability for network 100 to oblige various QoS levels based on exchanged information such QoS or priority identifiers contained in a TSPEC may provide benefits for transfer of certain media types (e.g. streaming audio and/or video data) often associated with multicasting.

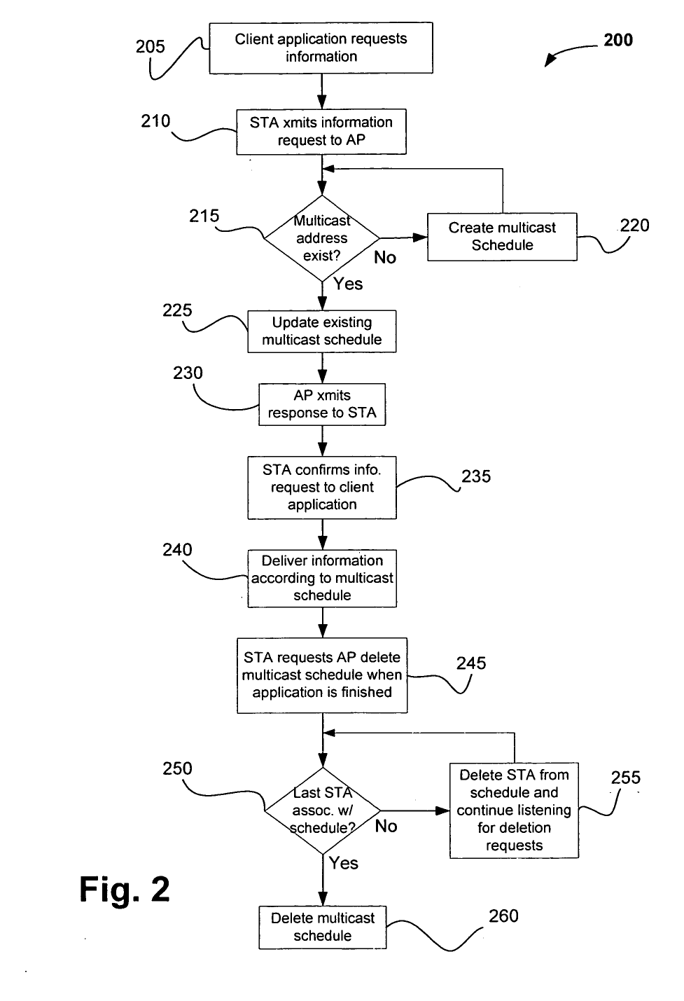

Turning to FIG. 2, a process 200 for sending and receiving multicast information in a wireless network may generally include a user station (STA) sending 210 a request for delivery of the information and delivering 240 the information from an access point (AP) to the STA according to a multicast schedule.

In certain example scenarios a client or station (STA) may be running an application program that may require information from the network. For instance, and by way of example only, an application may need to receive streaming video data from the network. In this example, according to one embodiment, the application may request 205 creation of a schedule for delivery of the information. The request may include a specific address for the source of the information and optionally certain QoS attributes desired for receiving the information.

The STA may then transmit 210 the request to an AP for processing. In one example WLAN embodiment, the STA media access controller (MAC) may generate the request, for example, including a multicast address and desired QoS attributes as part of a transmission specification (TSPEC) request which is sent via the air interface to the AP.

The AP may receive the request and schedule delivery of the information to meet the request 240. In one example implementation, the AP MAC may generate an indication of the TSPEC request (TSPEC indication) which may include the multicast address if present in the request. An AP management entity may use the TSPEC indication from the AP MAC to determine 215 whether the multicast address already exists in its stored schedule(s). If the multicast address does not exist, a multicast schedule for the multicast address may be created 220. On the other hand, if the multicast address does exist, the corresponding schedule may be updated 225 to include the requesting device for delivery of information. Creation of a multicast schedule may involve determining a transmission schedule which accommodates delivery of the information using the requested QoS attributes considering the APs other scheduling commitments (e.g., other TSPECs and/or beacon transmissions).

The AP may then notify 230 the requesting station of the scheduled delivery, using for example a TSPEC response or other type of response. In this case the STA MAC receiving the response confirms 235 the scheduled delivery of information to the application layer and coordinates the power-saving protocol of the device to ensure the STA is awake to receive the multicast data according to the AP defined multicast schedule.

Once a multicast schedule is created the ultimate source of the information (e.g., a network device sending a media stream to the AP) can be instructed to send application data packets to the AP's MAC using the multicast address as a destination MAC address if desired. The AP's MAC may buffer the received packets until the scheduled time and deliver 240 them to the requesting STAs substantially as scheduled.

Optionally, process 200 may further include actions for removing multicast schedules after the requested application data packets have been sent or are no longer needed. These actions may include each STA involved in a multicast sending 245 a schedule deletion request, preferably including the multicast address, when the application no longer needs or has finished receiving the information. When a deletion request is received by the AP, the AP references the multicast schedule by the included multicast address and determines 250 whether the requesting STA is the last station associated with the identified multicast schedule. If not, the requesting STA may be removed or deleted 255 from the multicast schedule and the AP maintains the multicast schedule in memory. If the received schedule deletion request is associated with the last remaining STA identified for the multicast schedule, the AP may delete 260 the multicast schedule. In certain embodiments, the schedule deletion request may be composed as a TSPEC request similar to that previously described if desired. Alternatively and/or additionally, the AP management entity may be configured to perform an automatic deletion of a multicast schedule after a predetermined time following completion of a multicast. In other embodiments, the AP may monitor the “liveness” of a STA by watching for traffic from the STA, or sending it a packet requiring acknowledgement in order to determine if it is still present. If the AP determines the STA is no longer present, the AP may act as though the STA had requested deletion of the multicast schedule.

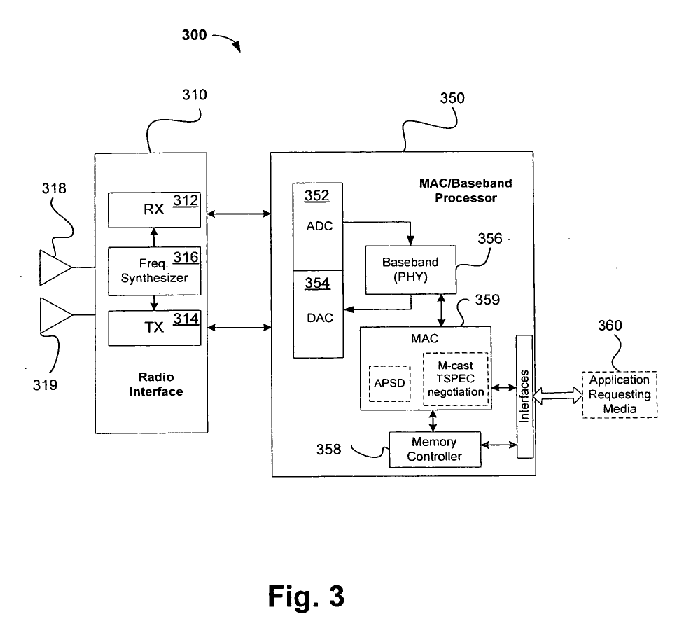

Turning to FIG. 3, an example wireless network apparatus 300 which may receive multicast information according to the various embodiments of the present invention may generally include a radio frequency (RF) interface 310 and a baseband and medium access controller (MAC) processor portion 350.

In one example embodiment, RF interface 310 may be any component or combination of components adapted to send and receive multi-carrier modulated signals. RF interface may include a receiver 312, transmitter 314 and frequency synthesizer 316. Interface 310 may also include bias controls, a crystal oscillator and/or one or more antennas 318, 319 if desired. Furthermore, RF interface 310 may alternatively or additionally use external voltage-controlled oscillators (VCOs), surface acoustic wave filters, IF filters and/or RF filters. Various RF interface designs and their operation are known in the art and the description thereof is therefore omitted.

In some embodiments interface 310 may be configured to be compatible with one or more of the Institute of Electrical and Electronics Engineers (IEEE) 802.11 frequency band standards for wireless local area networks (WLAN), however compatibility with other standards could also be implemented. Most preferably, interface 310 is configured for compatibility and/or backward compatibility with the IEEE 802.11(a-b) (g) and/or (n) standards for WLAN.

Baseband and MAC processing portion 350 communicates with RF interface 310 to process receive/transmit signals and may include, by way of example only, an analog-to-digital converter 352 for down converting received signals, a digital to analog converter 354 for up converting signals for transmission, a baseband processor 356 for physical (PHY) layer processing of respective receive/transmit signals, and one or more memory controllers 358 for managing read-write operations from one or more internal and/or external memories (not shown). Processing portion 350 may also include processor 359 for medium access control (MAC)/data link layer processing.

In certain embodiments of the present invention, processor 359 and/or additional circuitry may be adapted to handle requests for network media from an external or internal application 360 and to perform the actions for generating multicast TSPEC requests and/or handling TSPEC responses as described previously (e.g., 210, 235 and/or 245; FIG. 2). Alternatively or in addition, baseband processor 356 may share processing for these functions or perform these processes independent of processor 359. MAC and PHY processing may also be integrated into a single component if desired. Components and/or stored instructions for automatic power-save delivery (APSD) including a separate crystal oscillator (not shown) may also optionally be included as part of apparatus 300.

Apparatus 300 may be implemented as, for example, a battery-powered or alternating current (AC) device and/or network adaptor therefore. Accordingly, the previously described functions and/or specific configurations of apparatus 300 could be included or omitted as suitably desired.

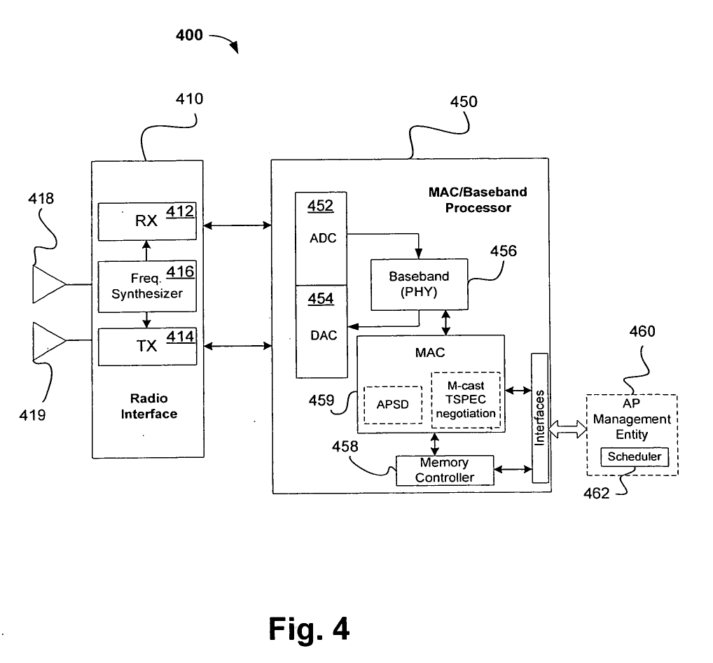

Referring to FIG. 4, a network access apparatus 400 (e.g. 120; FIG. 1) adapted to deliver multicast information in a wireless network is shown. Network access apparatus 400 is similar in nature to apparatus 300 of FIG. 3, and thus corresponding reference numerals may denote similar components. However, apparatus 400 includes, or interfaces with, an AP management entity 460 rather than the client application requesting the network data stream as shown in FIG. 3. AP management entity 460 may be any internal, external or distributed component, combination of components and/or machine readable code, which functions to manage AP performance and/or communications with various STAs including scheduling transmissions for multicast using, for example, scheduler 462. While not shown, apparatus 300 of FIG. 3 may include a similar functioning station management entity (SME).

The components and features of apparatuses 300, 400 may be implemented using any combination of discrete circuitry, application specific integrated circuits (ASICs), logic gates and/or single chip architectures. Further, the features of apparatus 400 may be implemented using microcontrollers, programmable logic arrays and/or microprocessors or any combination of the foregoing where suitably appropriate.

It should be appreciated that the example apparatuses 300, 400 shown in the block diagrams of FIGS. 3 and 4 are only one functionally descriptive example of many potential implementations. Accordingly, division, omission or inclusion of block functions depicted in FIGS. 3 and 4 does not infer that the hardware components, circuits, software and/or elements for implementing these functions would be necessarily be divided, omitted, or included in embodiments of the present invention.

Embodiments of the present invention may be implemented using single input single output (SISO) systems. However, as shown in FIGS. 3 and 4, certain preferred implementations may use multiple input multiple output (MIMO) systems having multiple antennas (e.g., 318, 319; FIG. 3 and 418, 419; FIG. 4). Further, embodiments of the invention may utilize multi-carrier code division multiplexing (MC-CDMA) multi-carrier direct sequence code division multiplexing (MC-DS-CDMA) or any other existing or future arising modulation or multiplexing scheme compatible with the features of the present invention.

Unless contrary to physical possibility, the inventor envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

1. A method for delivering information in a wireless network, the method comprising:
receiving from a client, a request for delivery of the information; and
sending the information to the client according to a multicast schedule.

2. The method of claim 1 further comprising:
sending a response to the client confirming scheduling of the request.

3. The method of claim 1 further comprising:
determining whether the multicast schedule exists for the request; and
if not, creating the multicast schedule.

4. The method of claim 1 wherein the request includes a multicast address and a quality of service (QoS) identifier.

5. The method of claim 1 further comprising:
deleting the multicast schedule after all clients associated with the multicast schedule have been sent the information.

6. The method of claim 5 wherein deleting the multicast schedule comprises receiving a deletion request from each client associated with the multicast schedule to delete the multicast schedule.

7. The method of claim 1 wherein the wireless network comprises a wireless local area network (WLAN) and wherein the request comprises a transmission specification (TSPEC) request.

8. The method of claim 2 wherein the response comprises a TSPEC response.

9. A method of receiving information in a wireless network, the method comprising:
sending a request for delivery of the information the request including a multicast designation address; and
configuring a power saving protocol to accommodate a scheduled delivery of the information.

10. The method of claim 9 further comprising receiving a response confirming the request.

11. The method of claim 9 wherein the request includes a multicast address.

12. The method of claim 9 wherein the request includes a quality of service (QoS) attribute.

13. The method of claim 9 wherein the wireless network comprises a wireless local area network (WLAN).

14. The method of claim 13 wherein the WLAN uses orthogonal frequency division multiplexing (OFDM).

15. The method of claim 9 wherein the request comprises a transmission specification (TSPEC).

16. The method of claim 9 further comprising sending a schedule deletion request to delete a multicast schedule.

17. A communication apparatus comprising:
a processing circuit adapted to coordinate a power saving mode of the apparatus with a multicast schedule specified by a network device.

18. The communication apparatus of claim 17 further comprising:
a radio frequency (RF) interface coupled to the processing circuit.

19. The apparatus of claim 17 wherein the processing portion includes a medium access controller (MAC) configured to request delivery of information from the network device.

20. The apparatus of claim 19 wherein the MAC is further configured to indicate confirmation of the requested delivery from the network device to an application.

21. The apparatus of claim 19 wherein the MAC is further configured to send a delete request message requesting removal of the apparatus from the multicast schedule.

22. The apparatus of claim 17 wherein the apparatus comprises a wireless user station (STA).

22. The apparatus of claim 17 wherein the apparatus comprises a network adaptor.

23. The apparatus of claim 18 further comprising at least two antennas coupled to the RF interface.

24. A communication apparatus comprising:
a processing circuit adapted to be able to determine a wireless multicast schedule in accordance with power saving modes of multiple client devices.

25. The device of claim 24 further comprising:
an RF interface coupled with the processing circuit and configured to transmit the wireless multicast according to the schedule determined by the processing circuit.

26. The apparatus of claim 24 wherein the apparatus comprises a wireless local area network (WLAN) access point.

27. The apparatus of claim 24 wherein scheduling of the wireless multicast is based one or more requests having a multicast address and received from one or more network devices.

28. The apparatus of claim 24 wherein the processing circuit is adapted to be able to send the schedule to one or more requesting network devices as a transmission specification (TSPEC) response.

29. The apparatus of claim 24 wherein the processing circuit is further adapted to be able to buffer application data packets for the wireless multicast until a time indicated on the schedule.

30. The apparatus of claim 25 further comprising at least two antennas coupled to the RF interfaces for enabling multiple input multiple output (MIMO) communications.

31. A communication system comprising:
a radio frequency (RF) transceiver;
at least two antennas electrically coupled to the RF transceiver; and
a data processing circuit electrically coupled with the RF transceiver,
wherein the data processing circuit is configured to be able to determine a wireless multicast schedule in accordance with power saving modes of multiple client devices.

32. The communication system of claim 31 wherein the data processing circuit is configured to be able to generate a multicast schedule based on received requests from the multiple client devices.

33. The communication system of claim 32 wherein the requests comprise a transmission specification (TSPEC) including a multicast address and a quality of service (QoS) indicator.

34. The communication system of claim 31 wherein the communication system comprises a wireless local area network (WLAN) access point (AP).
